(19) United States
(12) Patent Application Publication
(10) Pub. No.: US 2024/0422827 A1
(43) Pub. Date: Dec. 19, 2024

(54) BANDWIDTH PART SELECTION FOR RANDOM ACCESS PROCEDURES

(71) Applicant: NOKIA TECHNOLOGIES OY, Espoo (FI)

(72) Inventors: Samuli Heikki TURTINEN, Ii (FI); Jussi-Pekka KOSKINEN, Oulu (FI); Chunli WU, Beijing (CN)

(21) Appl. No.: 18/718,829

(22) PCT Filed: Dec. 15, 2021
(86) PCT No.: PCT/CN2021/138350

§ 371 Date: Jun. 12, 2024

(51) Int. Cl. H04W 74/0833; H04B 17/318; H04W 72/0457

(52) U.S. Cl. CPC H04W 74/0833; H04B 17/328; H04W 72/0457

(57) ABSTRACT

Example embodiments of the present disclosure relate to bandwidth part selections of random access procedure. According to embodiments of the present disclosure, a terminal device receives configuration information from a network device. The configuration information indicates a set of BWPs and configurations of the set of BWPs. When a random access procedure is triggered for a certain feature combination, the terminal device determines whether a condition for switching to a target BWP is fulfilled. If the condition is fulfilled, the terminal device switches to the target BWP. In this way, it improves resource efficiency.

### FIELD

Embodiments of the present disclosure generally relate to the field of telecommunication and in particular, to methods, devices, apparatuses and computer readable storage medium for selecting bandwidth part (BWP) for random access procedures.

### BACKGROUND

With development of communication systems, more and more technologies have been proposed. A physical random-access channel (PRACH) is a shared channel used by terminal devices to access the mobile network for cell set-up and burst data transmission. In order to access the PRACH, a terminal device may initiate a random access procedure. Moreover, the terminal device can be configured with one or more bandwidth parts (BWPs). A Bandwidth Part (BWP) is a contiguous set of physical resource blocks (PRBs) on a given carrier. These RBs are selected from a contiguous subset of the common resource blocks for a given numerology.

### SUMMARY

In general, example embodiments of the present disclosure provide a solution for determining a BWP for random access procedures.

In a first aspect, there is provided a first device. The first device comprises at least one processor; and at least one memory including computer program codes; the at least one memory and the computer program codes are configured to, with the at least one processor, cause the first device to: receive, from a second device, configuration information indicating: a set of bandwidth parts (BWPs) and a set of random access channel (RACH) configurations of the set of BWPs; determine, at the first device, that a random access procedure is triggered based on at least one feature; determine whether a condition for switching to a target BWP is fulfilled based on the set of RACH configurations, wherein the target BWP is configured with a RACH resource for the at least one feature; and in accordance with a determination that the condition is fulfilled, perform the random access with the second device on the target BWP.

In a second aspect, there is provided a second device. The second device comprises at least one processor; and at least one memory including computer program codes; the at least one memory and the computer program codes are configured to, with the at least one processor, cause the second device to: transmit, to a first device, configuration information indicating: a set of bandwidth parts (BWPs) and a set of random access channel (RACH) configurations of the set of BWPs; and perform a random access with the first device on a target BWP, wherein the random access procedure is triggered based on at least one feature and the target BWP is configured with a RACH resource for the at least one feature.

In a third aspect, there is provided a method. The method comprises receiving, at a first device and from a second device, configuration information indicating: a set of bandwidth parts (BWPs) and a set of random access channel (RACH) configurations of the set of BWPs; determining, at the first device, that a random access procedure is triggered based on at least one feature; determining whether a condition for switching to a target BWP is fulfilled based on the set of RACH configurations, wherein the target BWP is configured with a RACH resource for the at least one feature; and in accordance with a determination that the condition is fulfilled, performing the random access with the second device on the target BWP.

In a fourth aspect, there is provided a method. The method comprises transmitting, at a second device and to a first device, configuration information indicating: a set of bandwidth parts (BWPs) and a set of random access channel (RACH) configurations of the set of BWPs; and performing a random access with the first device on a target BWP, wherein the random access procedure is triggered based on at least one feature and the target BWP is configured with a RACH resource for the at least one feature.

In a fifth aspect, there is provided an apparatus. Thus apparatus comprises: means for receiving, at a first device and from a second device, configuration information indicating: a set of bandwidth parts (BWPs) and a set of random access channel (RACH) configurations of the set of BWPs; means for determining, at the first device, that a random access procedure is triggered based on at least one feature; means for determining whether a condition for switching to a target BWP is fulfilled based on the set of RACH configurations, wherein the target BWP is configured with a RACH resource for the at least one feature; and means for in accordance with a determination that the condition is fulfilled, performing the random access with the second device on the target BWP.

In a sixth aspect, there is provided an apparatus. Thus apparatus comprises: means for transmitting, at a second device and to a first device, configuration information indicating: a set of bandwidth parts (BWPs) and a set of random access channel (RACH) configurations of the set of BWPs; and means for performing a random access with the first device on a target BWP, wherein the random access procedure is triggered based on at least one feature and the target BWP is configured with a RACH resource for the at least one feature.

In a seventh aspect, there is provided a computer readable medium. The computer readable medium comprises program instructions for causing an apparatus to perform at least the method according to any one of the above third and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for selecting proper resources for a random access procedure according to some example embodiments of the present disclosure;

FIG. 3 illustrates a schematic diagram of BWPs according to some example embodiments of the present disclosure;

FIG. 4 illustrates a flowchart of a method implemented at a first apparatus according to some example embodiments of the present disclosure;

FIG. 5 illustrates a flowchart of a method implemented at a first apparatus according to some example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, the gNB can be split into a centralized unit (CU) and a decentralized unit (DU). That CU hosts the higher layers of the protocol stack including the radio resource control (RRC) and packet data convergence protocol (PDCP) while the DU hosts the lower layers such as the physical layer, medium access control (MAC) layer and radio link control (RLC) layer.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the terminal device may initiate the random access procedure to access the PRACH. Random Access Procedure (RACH) can be contention based (CBRA) or contention free (CFRA). A technique named “RACH partition” has been proposed. The RACH partition strategy may be optimized to increase the access performances of networks. For example, based on different types of services, the RACH partition strategy may partition and allocate random access channel (RACH) resources to each type of service. The term “RACH resources” used herein can refer to time/frequency resources used for RACH (i.e., the so-called RACH occasions-ROs) or preambles of the RACH and RACH partitioning can either be achieved by partitioning the PRACH resources (i.e., different RACH occasions are mapped to different features) or by partitioning the preambles associated with a RACH occasion (i.e., different preambles of a RO are mapped to different features). Moreover, the terminal device can be configured with one or more BWPs. A terminal device can be configured with maximum 4 BWPs for downlink and uplink but at a given point of time only one BWP is active for downlink and one for uplink.

As configuration of many different RACH partitions is a burden for the network device, these would likely be configured only on certain BWPs where most of the terminal devices can take advantage of the RACH partitions, for instance, in initial BWP. Hence, whenever the terminal device operates on a dedicated BWP that may not have the RACH partition available for the feature set it triggered the RA procedure, it would use the common RACH (if configured on the BWP) while that may not provide optimal performance for the terminal device.

In order to solve at least part of the above and other potential problems, a new solution on selecting proper BWP for a random access procedure is needed. According to embodiments of the present disclosure, a terminal device receives configuration information from a network device. The configuration information indicates a set of BWPs and RACH configurations of the set of BWPs. When a random access procedure is triggered for a certain feature combination, the terminal device determines whether a condition for switching to a target BWP is fulfilled. If the condition is fulfilled, the terminal device switches to the target BWP. In this way, it improves resource efficiency.

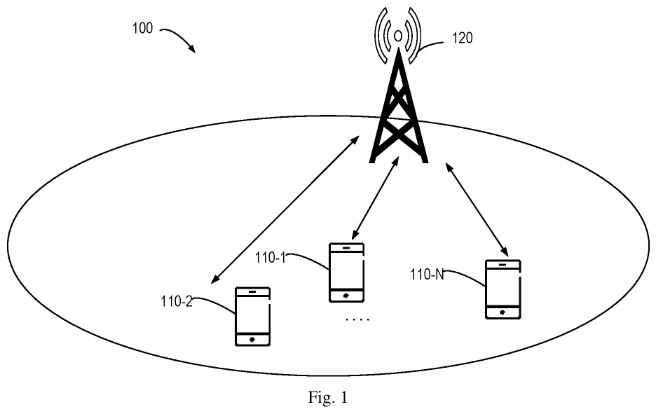

FIG. 1 illustrates a schematic diagram of a communication environment 100 in which embodiments of the present disclosure can be implemented. The communication environment 100, which is a part of a communication network, comprises a device 110-1, a device 110-2, . . . , a device 110-N, which can be collectively referred to as “first device(s) 110.” The communication environment 100 further comprises a second device 120 that can communicate with the first device(s) 110.

The communication environment 100 may comprise any suitable number of devices and cells. In the communication environment 100, the first device 110 and the second device 120 can communicate data and control information to each other. In the case that the first device 110 is the terminal device and the second device 120 is the network device, a link from the second device 120 to the first device 110 is referred to as a downlink (DL), while a link from the first device 110 to the second device 120 is referred to as an uplink (UL). The second device 120 and the first device 110 are interchangeable.

It is to be understood that the number of first devices and cells and their connections shown in FIG. 1 is given for the purpose of illustration without suggesting any limitations. The environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

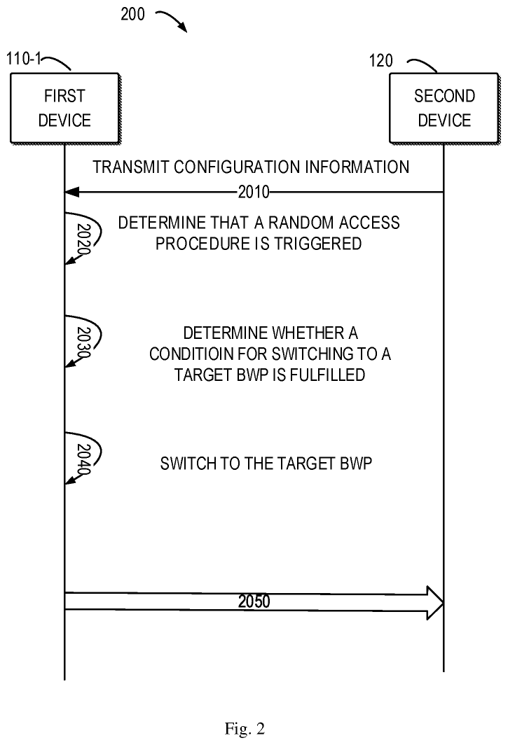

Example embodiments of the present disclosure will be described in detail below with reference to the accompanying drawings. Reference is now made to FIG. 2, which illustrates a signaling flow 200 for selecting resources for random access procedures according to example embodiments of the present disclosure. For the purpose of discussion, the signaling flow 200 will be described with reference to FIG. 1. The signaling flow 200 may involve the first device 110-1 and the second device 120.

The second device 120 transmits 2010 configuration information to the first device 110-1. The configuration information indicates a set of BWPs and a set of RACH configurations of the set of BWPs. In some example embodiments, the configuration information can be transmitted via RRC signaling. Alternatively, the configuration information can be transmitted via medium access control (MAC) signaling. In other embodiments, the configuration information may be transmitted via physical layer (PHY) signaling.

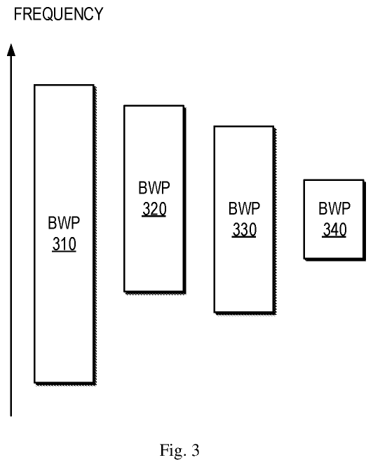

In some example embodiments, the configuration information may comprise indexes of the BWPs and the corresponding RACH configuration of each BWP. Each BWP defined for a numerology can have following three different parameters: subcarrier spacing, symbol duration and cyclic prefix length. The RACH configuration can comprise one or more of: BWP bandwidth size frequency location, and control resource set (CORESET). Each DL BWP may include at least one CORESET with UE Specific Search Space (USS) while Primary carrier at least one of the configured DL BWPs includes one CORESET with common search space (CSS). With respect to uplink, the terminal device shall not transmit PUSCH or PUCCH outside an active bandwidth part. There is an initial active BWP for the terminal device during the initial access until the terminal device during is explicitly configured with BWPs during or after RRC connection establishment. The term “initial BWP” used herein can refer to a BWP which is used to perform an initial access process. The term “active BWP” used herein can refer to a UE specific/dedicated BWP which cannot be used to perform the access process. The active BWP is the BWP which the terminal device uses for data transfer when the RRC connection is established. The term “default BWP” used herein can refer to a UE specific BWP which configured during RRC reconfiguration. If the default BWP is not configured, the initial BWP can be referred as the default BWP. For example, as shown in FIG. 3, the configuration information may comprise the RACH configurations of the BWP310, BWP320, BWP330 and BWP340. Only as an example, the BWP310 can be the initial BWP, the BWP320 can be the active BWP and the BWP340 can be the default BWP. It should be noted that FIG. 3 is only an example not a limitation.

In other embodiments, the configuration information may comprise a set of features which can trigger a random access procedure. The term “feature” used herein can refer to a cause that can trigger the random access procedure. In this case, the configuration information may also indicate that one or more BWPs in the set of BWPs are configured with a RACH resource for one or more features. Alternatively, the configuration information may also indicate that one or more BWPs in the set of BWPs are not configured with a RACH resource for one or more features. It should be noted that Table 1 is only one example and other combinations of features and priorities may be possible.

TABLE 1

| Feature | Reason for RACH indication |
|---|---|
| Reduced | To indicate reduced capabilities to the |
| capability (RedCap) | network in MSG1 so that the network can |
| | adapt subsequent transmissions |
| Small Data | To request a larger MSG3 size (or MSGA |
| Transmission (SDT) | size in case of 2-step RA) and to indicate |
| | SDT procedure. |
| Coverage | To indicate need for coverage enhancement |
| Enhancement (CovEnh) | (esp. for request of MSG3 repetition) |
| Slicing | To indicate high priority slice to the |
| | network and to achieve slice isolation also |
| | for RACH |

The first device 110-1 determines 2020 a random access procedure is triggered based on at least one feature. For example, the at least one feature may comprise one or more of: RedCap, SDT, CovEnh or slicing. It should be noted that the plurality of features can comprise other features.

The first device 110-1 determines 2030 whether a condition for switching to a target BWP is fulfilled. In some example embodiments, the condition may be comprised in the configuration information received from the second device 120. Alternatively, the condition may be predefined at the first device 110-1. If the condition is fulfilled, the first device 110-1 switches 2040 to the target BWP. In this way, when the random access is triggered in the RRC connected mode, the first device 110-1 may not only take the RACH configuration of the active BWP but also take the RACH configurations of the set of BWPs into consideration, thereby improving resource efficiency and distributing RACH load. It should be noted that embodiments of the present disclosure can also be applicable for RRC Idle and RRC Inactive states.

In some example embodiments, the first device 110-1 may first determine whether the active BWP is configured with the RACH resource for the at least one feature. If the active BWP is not configured with the RACH resource for the at least one feature, the first device 110-1 may switch to the initial BWP. In this case, the first device 110-1 may further determine whether the initial BWP is configured with the RACH resource for the at least one feature. For example, with the reference to FIG. 3, if the BWP320 is not configured with the RACH resource for the at least one feature, the first device 110-1 may switch to the BWP310. If the initial BWP is configured with the RACH resource for the at least one feature, the initial BWP can be regarded as the target BWP. If the initial BWP is not configured with the RACH resource for the at least one feature, the first device 110-1 may determine whether other BWP (for example, the BWP330 and BWP340) in the set of BWPS is configured with the RACH resource for the at least one feature. If the other BWP is configured with the RACH resource for the at least one feature, the initial BWP can be regarded as the target BWP. In this way, it has less impact on the current mechanism and it is easy to implement. In some examples, in case the random access procedure is triggered based on plurality of features, the first device 110-1 may determine the priorities of the plurality of the features and determine the feature with highest priority to be the at least one feature.

Alternatively, the first device 110-1 may first determine whether any BWP in the set of BWPs is configured with the RACH resource for the at least one feature. In this case, if a BWP is configured with the RACH resource for the at least one feature, such BWP can be regarded as the target BWP. In other embodiments, if no BWP in the set of BWPs is configured with the RACH resource for the at least one feature, the first device 110-1 may perform the random access on the active BWP. Alternatively, if no BWP in the set of BWPs is configured with the RACH resource for the at least one feature, the first device 110-1 may switch to the initial BWP. In this case, the first device 110-1 may perform the random access on the initial BWP. In this way, a proper BWP can be selected quickly.

In some example embodiments, if the random access for coverage enhancement is triggered, the first device 110-1 may determine whether the active BWP is configured with the RACH resource for the coverage enhancement based on the set of RACH configurations. In this case, if the active BWP is not configured with the RACH resource for the coverage enhancement and the condition in the configuration information may indicate a first reference signal received power (RSRP) threshold for coverage enhancement, the first device 110-1 may compare a value of the RSRP on the active BWP with the first RSRP threshold. The first device 110-1 may determine whether the value of the RSRP on the active BWP is below the first RSRP threshold based on the comparison. If the value of the RSRP is below the first RSRP threshold, the first device 110-1 may switch to the target BWP which is configured with the RACH resource for coverage enhancement. For example, if the value of the RSRP of the BWP320 is below the first RSRP threshold and the configuration information indicates that the BWP330 is configured with the RACH resource for coverage enhancement, the first device 110-1 can switch to the BWP330. In this way, the BWP for the random access can be selected properly.

In other embodiments, if the random access for reduced capability is triggered, the first device 110-1 may determine whether the active BWP is configured with the RACH resource for the reduced capability based on the set of RACH configurations. In this case, if the active BWP is not configured with the RACH resource for the reduced capability and the condition in the configuration information may indicate a second RSRP threshold for reduced capability, the first device 110-1 may compare a value of the RSRP on the active BWP with the second RSRP threshold. The first device 110-1 may determine whether the value of the RSRP on the active BWP is below the second RSRP threshold based on the comparison. If the value of the RSRP is below the second RSRP threshold, the first device 110-1 may switch to the target BWP which is configured with the RACH resource for reduced capability. For example, if the value of the RSRP of the BWP320 is below the second RSRP threshold and the configuration information indicates that the BWP340 is configured with the RACH resource for reduced capability, the first device 110-1 can switch to the BWP340. The second RSRP threshold can be different for 1RX (receiver/receiver chain/receiver branch) and 2RX terminal devices. In one example, the second RSRP threshold can be applied also by IDLE/INACTIVE RedCap terminal devices to determine whether to access via RedCap specific initial BWP or the cell initial BWP (if RedCap UE can also support the BW of the cell initial BWP). In this way, the BWP for the random access can be selected properly.

Alternatively, if the random access for reduced capability is triggered, the first device 110-1 may determine whether the active BWP is configured with the RACH resource for the reduced capability based on the set of RACH configurations. If the active BWP is not configured with the RACH resource for the reduced capability, the first device 110-1 may switch to the target BWP which is configured with the RACH resource for reduced capability. In one example embodiment, if the first device 110-1 supports only 1RX (receiver/receiver chain), the first device 110-1 may always switch to the BWP supporting reduced capability specific RACH partition whenever such BWP is available. In this way, the BWP for the random access can be selected properly.

In some example embodiments, if the random access for a slice/slice group is triggered, the first device 110-1 may determine whether the active BWP is configured with the RACH resource for the slice/slice group based on the set of RACH configurations. If the active BWP is not configured with the RACH resource for the slice/slice group, the first device 110-1 may switch to the target BWP which is configured with the RACH resource for the slice. For example, if the BWP320 is not configured with the RACH resource for the slice/slice group and the configuration information indicates that the BWP330 is configured with the RACH resource for the slice/slice group, the first device 110-1 can switch to the BWP330. In this way, the BWP for the random access can be selected properly and the RACH load can be distributed.

In an example embodiment, the second device 120 may explicitly configure the first device 110-1 to perform the random access on the active BWP if there is RACH resource configured for the active BWP. In other words, the BWP switching for the random access can be disabled. For example, the second device 120 may transmit downlink control information or RRC configuration which comprises the disable indication for the BWP switching to the first device 110-1.

Referring back to FIG. 2, the first device 110-1 performs 2050 the random access with the second device 120 on the target BWP. In some embodiments, after the random access is triggered, the first device 110-1 may perform the random access on the active BWP which is configured with a common RACH resource. If the number of random access failures exceeds a number threshold, the first device 110-1 may determine that the condition for switching to the target BWP is fulfilled. In this case, the first device 110-1 can switch to the target BWP which is configured with the RACH resource for the at least one feature. The number threshold can be configured by the second device 120 via any proper signaling. Alternatively, the number threshold can be predefined at the first device 110-1.

According to above embodiments, feature specific RACH partitions can be applied also in CONNECTED mode, for instance, when the network device expects a 1RX RedCap UE not to survive over the common RACH (e.g., due to RAR coverage issues). Moreover, it enables BWP switching based on feature specific RA partitioning, which improves resource efficiency as it would not require the NW to duplicate RA partitioning for dedicated BWPs to benefit from it. Further, RACH load distribution can be achieved by distributing the feature specific RACH partitions to different BWPs.

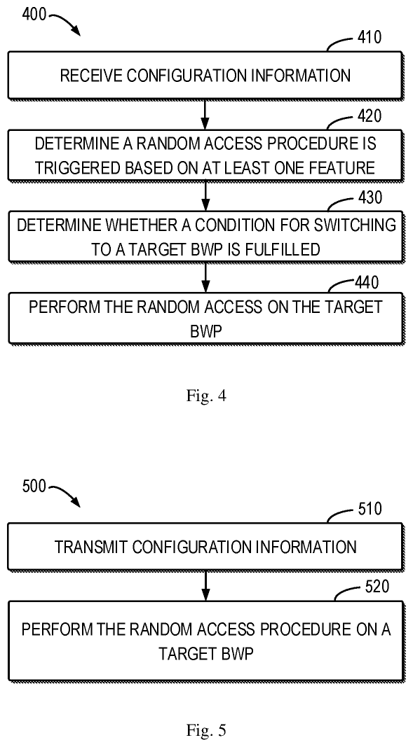

FIG. 4 shows a flowchart of an example method 400 implemented at a first device 110-1 in accordance with some example embodiments of the present disclosure.

At block 410, the first device 110-1 receives configuration information from the second device 120. The configuration information indicates a set of BWPs and a set of RACH configurations of the set of BWPs. In some example embodiments, the configuration information can be transmitted via RRC signaling. Alternatively, the configuration information can be transmitted via MAC signaling. In other embodiments, the configuration information may be transmitted via PHY signaling.

In some example embodiments, the configuration information may comprise indexes of the BWPs and the corresponding RACH configuration of each BWP. Each BWP defined for a numerology can have following three different parameters: subcarrier spacing, symbol duration and cyclic prefix length. The RACH configuration can comprise one or more of: BWP bandwidth size frequency location, and control resource set (CORESET). Each DL BWP may include at least one CORESET with UE Specific Search Space (USS) while Primary carrier at least one of the configured DL BWPs includes one CORESET with common search space (CSS). With respect to uplink, the terminal device shall not transmit PUSCH or PUCCH outside an active bandwidth part. There is an initial active BWP for the terminal device during the initial access until the terminal device during is explicitly configured with BWPs during or after RRC connection establishment.

In other embodiments, the configuration information may comprise a set of features which can trigger a random access procedure. The term “feature” used herein can refer to a cause that can trigger the random access procedure. In this case, the configuration information may also indicate that one or more BWPs in the set of BWPs are configured with a RACH resource for one or more features. Alternatively, the configuration information may also indicate that one or more BWPs in the set of BWPs are not configured with a RACH resource for one or more features.

At block 420, the first device 110-1 determines a random access procedure is triggered based on at least one feature. For example, the at least one feature may comprise one or more of: RedCap, SDT, CovEnh or slicing. It should be noted that the plurality of features can comprise other features.

At block 430, the first device 110-1 determines whether a condition for switching to a target BWP is fulfilled. In some example embodiments, the condition may be comprised in the configuration information received from the second device 120. Alternatively, the condition may be predefined at the first device 110-1.

At block 440, if the condition is fulfilled, the first device 110-1 performs the random access with the second device 120 on the target BWP. In this way, when the random access is triggered in the RRC connected mode, the first device 110-1 may not only take the RACH configuration of the active BWP but also take the RACH configurations of the set of BWPs into consideration, thereby improving resource efficiency and distributing RACH load.

In some example embodiments, the first device 110-1 may first determine whether the active BWP is configured with the RACH resource for the at least one feature. If the active BWP is not configured with the RACH resource for the at least one feature, the first device 110-1 may switch to the initial BWP. In this case, the first device 110-1 may further determine whether the initial BWP is configured with the RACH resource for the at least one feature. If the initial BWP is configured with the RACH resource for the at least one feature, the initial BWP can be regarded as the target BWP. If the initial BWP is not configured with the RACH resource for the at least one feature, the first device 110-1 may determine whether other BWP in the set of BWPS is configured with the RACH resource for the at least one feature. If the other BWP is configured with the RACH resource for the at least one feature, the initial BWP can be regarded as the target BWP. In this way, it has less impact on the current mechanism and it is easy to implement. In some examples, in case the random access procedure is triggered based on plurality of features, the first device 110-1 may determine the priorities of the plurality of the features and determine the feature with highest priority to be the at least one feature.

Alternatively, the first device 110-1 may first determine whether any BWP in the set of BWPs is configured with the RACH resource for the at least one feature. In this case, if a BWP is configured with the RACH resource for the at least one feature, such BWP can be regarded as the target BWP. In other embodiments, if no BWP in the set of BWPs is configured with the RACH resource for the at least one feature, the first device 110-1 may perform the random access on the active BWP. Alternatively, if no BWP in the set of BWPs is configured with the RACH resource for the at least one feature, the first device 110-1 may switch to the initial BWP. In this case, the first device 110-1 may perform the random access on the initial BWP. In this way, a proper BWP can be selected quickly.

In some example embodiments, if the random access for coverage enhancement is triggered, the first device 110-1 may determine whether the active BWP is configured with the RACH resource for the coverage enhancement based on the set of RACH configurations. In this case, if the active BWP is not configured with the RACH resource for the coverage enhancement and the condition in the configuration information may indicate a first reference signal received power (RSRP) threshold for coverage enhancement, the first device 110-1 may compare a value of the RSRP on the active BWP with the first RSRP threshold. The first device 110-1 may determine whether the value of the RSRP on the active BWP is below the first RSRP threshold based on the comparison. If the value of the RSRP is below the first RSRP threshold, the first device 110-1 may switch to the target BWP which is configured with the RACH resource for coverage enhancement. In this way, the BWP for the random access can be selected properly.

In other embodiments, if the random access for reduced capability is triggered, the first device 110-1 may determine whether the active BWP is configured with the RACH resource for the reduced capability based on the set of RACH configurations. In this case, if the active BWP is not configured with the RACH resource for the reduced capability and the condition in the configuration information may indicate a second RSRP threshold for reduced capability, the first device 110-1 may compare a value of the RSRP on the active BWP with the second RSRP threshold. The first device 110-1 may determine whether the value of the RSRP on the active BWP is below the second RSRP threshold based on the comparison. If the value of the RSRP is below the second RSRP threshold, the first device 110-1 may switch to the target BWP which is configured with the RACH resource for reduced capability. The second RSRP threshold can be different for 1RX and 2RX terminal devices. In one example, the second RSRP threshold can be applied also by IDLE/INACTIVE RedCap terminal devices to determine whether to access via RedCap specific initial BWP or the cell initial BWP (if RedCap UE can also support the BW of the cell initial BWP). In this way, the BWP for the random access can be selected properly.

Alternatively, if the random access for reduced capability is triggered, the first device 110-1 may determine whether the active BWP is configured with the RACH resource for the reduced capability based on the set of RACH configurations. If the active BWP is not configured with the RACH resource for the reduced capability, the first device 110-1 may switch to the target BWP which is configured with the RACH resource for reduced capability. In one example embodiment, if the first device 110-1 supports only 1RX (receiver/receiver chain), the first device 110-1 may always switch to the BWP supporting reduced capability specific RACH partition whenever such BWP is available. In this way, the BWP for the random access can be selected properly.

In some example embodiments, if the random access for slice/slice group is triggered, the first device 110-1 may determine whether the active BWP is configured with the RACH resource for the slice/slice group based on the set of RACH configurations. If the active BWP is not configured with the RACH resource for the slice/slice group, the first device 110-1 may switch to the target BWP which is configured with the RACH resource for the slice. In this way, the BWP for the random access can be selected properly and the RACH load can be distributed.

In an example embodiment, the second device 120 may explicitly configure the first device 110-1 to perform the random access on the active BWP if there is RACH resource configured for the active BWP. In other words, the BWP switching for the random access can be disabled. For example, the second device 120 may transmit downlink control information or RRC configuration which comprises the disable indication for the BWP switching to the first device 110-1.

In some embodiments, after the random access is triggered, the first device 110-1 may perform the random access on the active BWP which is configured with a common RACH resource. If the number of random access failures exceeds a number threshold, the first device 110-1 may determine that the condition for switching to the target BWP is fulfilled. In this case, the first device 110-1 can switch to the target BWP which is configured with the RACH resource for the at least one feature. The number threshold can be configured by the second device 120 via any proper signaling. Alternatively, the number threshold can be predefined at the first device 110-1.

FIG. 5 shows a flowchart of an example method 500 implemented at a second device 120 in accordance with some example embodiments of the present disclosure.

At block 510, the second device 120 transmits configuration information to the first device 110-1. The configuration information indicates a set of BWPs and a set of RACH configurations of the set of BWPs. In some example embodiments, the configuration information can be transmitted via RRC signaling. Alternatively, the configuration information can be transmitted via MAC signaling. In other embodiments, the configuration information may be transmitted via PHY signaling.

In some example embodiments, the configuration information may comprise indexes of the BWPs and the corresponding RACH configuration of each BWP. Each BWP defined for a numerology can have following three different parameters: subcarrier spacing, symbol duration and cyclic prefix length. The RACH configuration can comprise one or more of: BWP bandwidth size frequency location, and control resource set (CORESET). Each DL BWP may include at least one CORESET with UE Specific Search Space (USS) while Primary carrier at least one of the configured DL BWPs includes one CORESET with common search space (CSS). With respect to uplink, the terminal device shall not transmit PUSCH or PUCCH outside an active bandwidth part. There is an initial active BWP for the terminal device during the initial access until the terminal device during is explicitly configured with BWPs during or after RRC connection establishment.

In other embodiments, the configuration information may comprise a set of features which can trigger a random access procedure. The term “feature” used herein can refer to a cause that can trigger the random access procedure. In this case, the configuration information may also indicate that one or more BWPs in the set of BWPs are configured with a RACH resource for one or more features. Alternatively, the configuration information may also indicate that one or more BWPs in the set of BWPs are not configured with a RACH resource for one or more features.

At block 520, the second device 120 performs a random access with the first device 110-1 on a target BWP which is configured with a RACH resource for the at least one feature.

In some example embodiments, a first apparatus capable of performing any of the method 400 (for example, the first device 110) may comprise means for performing the respective operations of the method 400. The means may be implemented in any suitable form. For example, the means may be implemented in a circuitry or software module. The first apparatus may be implemented as or included in the first device 110. In some example embodiments, the means may comprise at least one processor and at least one memory including computer program code. The at least one memory and computer program code are configured to, with the at least one processor, cause performance of the apparatus.

In some embodiments, the first apparatus comprises means for receiving, at a first device and from a second device, configuration information indicating: a set of bandwidth parts (BWPs) and a set of random access channel (RACH) configurations of the set of BWPs; means for determining, at the first device, that a random access procedure is triggered based on at least one feature; means for determining whether a condition for switching to a target BWP is fulfilled based on the set of RACH configurations, wherein the target BWP is configured with a RACH resource for the at least one feature; and means for in accordance with a determination that the condition is fulfilled, performing the random access with the second device on the target BWP.

In some embodiments, the set of RACH configurations further comprises the condition for switching to the target BWP.

In some embodiments, the at least one feature comprises one of: a reduced capability, a small data transmission, a coverage enhancement, or a slice.

In some embodiments, the condition indicates a first reference signal received power (RSRP) threshold for coverage enhancement, the first apparatus further comprises: means for determining whether an active BWP of the first device is configured with a RACH resource for coverage enhancement based on the set of RACH configurations; means for in accordance with a determination that the active BWP is not configured with the RACH resource for coverage enhancement, determining a value of the RSRP on the active BWP; and means for determining whether the condition for switching to the target BWP is fulfilled comprises: means for comparing the value of the RSRP of the active BWP with the first RSRP threshold; means for in accordance with a determination that the value of RSRP is below the first RSRP threshold, determining that the condition for switching to the target BWP is fulfilled; means for switching from the active BWP to the target BWP which is configured with the RACH resource for coverage enhancement.

In some embodiments, the condition indicates a second RSRP threshold associated with reduced capability, the first apparatus further comprises: means for determining a value of the RSRP on an active BWP; and means for determining whether the condition for switching to the target BWP is fulfilled comprises: means for comparing the value of the RSRP of the active BWP with the second RSRP threshold; means for in accordance with a determination that the value of RSRP is below the second RSRP threshold, determining that the condition for switching to the target BWP is fulfilled; and means for switching from the active BWP to the target BWP which is configured with the RACH resource for reduced capability.

In some embodiments, the means for determining whether the condition for switching to the target BWP is fulfilled comprises: means for determining whether an active BWP is configured a RACH resource for the reduced capability; and means for in accordance with a determination that the active BWP is not configured the RACH resource for the reduced capability, switching from the active BWP to the target BWP which is configured with the RACH resource for reduced capability.

In some embodiments, the means for determining whether the condition for switching to the target BWP is fulfilled comprises: means for determining whether an active BWP is configured a RACH resource for a slice; and means for in accordance with a determination that the active BWP is not configured the RACH resource for the slice, switching from the active BWP to the target BWP which is configured with the RACH resource for the slice.

In some embodiments, the first apparatus comprises means for determining whether an active BWP of the first device is configured with a RACH configuration based on the set of RACH configurations; means for in accordance with a determination that the active BWP is not configured with the RACH configuration, switching to an initial BWP; and the means for determining whether the condition for switching to the target BWP is fulfilled comprises: means for in accordance with a determination that the initial BWP does not support the at least one feature, determining whether the condition for switching to the target BWP is fulfilled.

In some embodiments, the means for determining whether the condition for switching to the target BWP is fulfilled comprises: means for performing a random access on an active BWP which is configured with a common RACH resource; and means for in accordance with a determinations that the number of random access failures on the active BWP exceeds a number threshold, determining that the condition for switching to the target BWP is fulfilled.

In some embodiments, the means for receiving the configuration information comprises: means for receiving the configuration information via one of: a radio resource control (RRC) signaling, a medium access control (MAC) signaling, or a physical (PHY) signaling.

In some embodiments, the first device is a terminal device and the second device is a network device.

In some example embodiments, a second apparatus capable of performing any of the method 500 (for example, the second device 120) may comprise means for performing the respective operations of the method 500. The means may be implemented in any suitable form. For example, the means may be implemented in a circuitry or software module. The first apparatus may be implemented as or included in the second device 120. In some example embodiments, the means may comprise at least one processor and at least one memory including computer program code. The at least one memory and computer program code are configured to, with the at least one processor, cause performance of the apparatus.

In some embodiments, the second apparatus comprises means for transmitting, at a second device and to a first device, configuration information indicating: a set of bandwidth parts (BWPs) and a set of random access channel (RACH) configurations of the set of BWPs; and means for performing a random access with the first device on a target BWP, wherein the random access procedure is triggered based on at least one feature and the target BWP is configured with a RACH resource for the at least one feature.

In some embodiments, the set of RACH configurations further comprises the condition for switching to the target BWP.

In some embodiments, the at least one feature comprises one of: a reduced capability, a small data transmission, a coverage enhancement, or a slice.

In some embodiments, the condition indicates a first reference signal received power (RSRP) threshold for coverage enhancement.

In some embodiments, the condition indicates a second RSRP threshold associated with reduced capability.

In some embodiments, the means for transmitting the configuration information comprises: means for transmitting the configuration information via one of: a radio resource control (RRC) signaling, a medium access control (MAC) signaling, or a physical (PHY) signaling.

In some embodiments, the first device is a terminal device and the second device is a network device

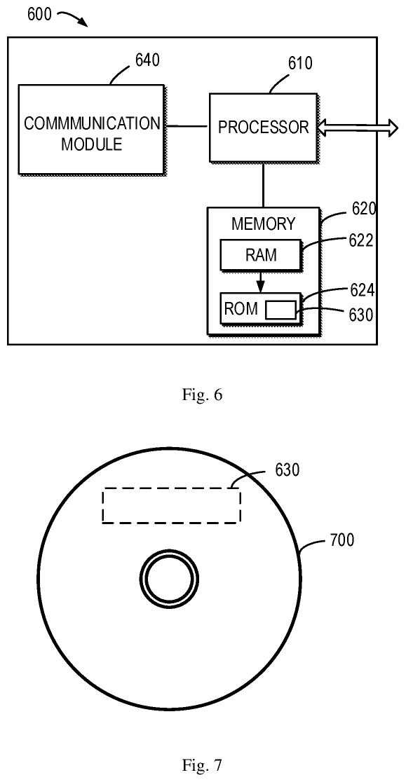

FIG. 6 is a simplified block diagram of a device 600 that is suitable for implementing example embodiments of the present disclosure. The device 600 may be provided to implement a communication device, for example, the first device 110 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the memory, e.g., ROM 624. The processor 610 may perform any suitable actions and processing by loading the program 630 into the RAM 622.

Some example embodiments of the present disclosure may be implemented by means of the program 630 so that the device 600 may perform any process of the disclosure as discussed with reference to FIGS. 2 to 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and other magnetic storage and/or optical storage. FIG. 7 shows an example of the computer readable medium 700 in form of an optical storage disk. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 2 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
wherein the at least one memory and the computer program code are configured to, with the at least one processor, cause the first device to:
receive, from a second device, configuration information indicating: a set of bandwidth parts (BWPs) and a set of random access channel (RACH) configurations of the set of BWPs;
determine, at the first device, that a random access procedure is triggered based on at least one feature;
determine whether a condition for switching to a target BWP is fulfilled based on the set of RACH configurations, wherein the target BWP is configured with a RACH resource for the at least one feature; and
in accordance with a determination that the condition is fulfilled, perform the random access with the second device on the target BWP.

2. The first device of claim 1, wherein the set of RACH configurations further comprises the condition for switching to the target BWP.

3. The first device of claim 1, wherein the at least one feature comprises one of:
a reduced capability,
a small data transmission,
a coverage enhancement, or
a slice.

4. The first device of claim 1, wherein the condition indicates a first reference signal received power (RSRP) threshold for coverage enhancement, and
wherein the at least one memory and the computer program codes are configured to, with the at least one processor, further cause the first device to:
determine whether an active BWP of the first device is configured with a RACH resource for coverage enhancement based on the set of RACH configurations;
in accordance with a determination that the active BWP is not configured with the RACH resource for coverage enhancement, determine a value of a RSRP on the active BWP; and
wherein the at least one memory and the computer program codes are configured to, with the at least one processor, cause the first device to determine whether the condition for switching to the target BWP is fulfilled by:
comparing the value of the RSRP of the active BWP with the first RSRP threshold;
in accordance with a determination that the value of RSRP is below the first RSRP threshold, determining that the condition for switching to the target BWP is fulfilled; and
switching from the active BWP to the target BWP which is configured with the RACH resource for coverage enhancement.

5. The first device of claim 1, wherein the condition indicates a second RSRP threshold associated with reduced capability, and
wherein the at least one memory and the computer program codes are configured to, with the at least one processor, further cause the first device to:
determine a value of a RSRP on an active BWP; and
wherein the at least one memory and the computer program codes are configured to, with the at least one processor, further cause the first device to determine whether the condition for switching to the target BWP is fulfilled by:
comparing the value of the RSRP of the active BWP with the second RSRP threshold;
in accordance with a determination that the value of the RSRP is below the second RSRP threshold, determining that the condition for switching to the target BWP is fulfilled; and
switching from the active BWP to the target BWP which is configured with the RACH resource for reduced capability.

6. The first device of claim 1, wherein the at least one memory and the computer program codes are configured to, with the at least one processor, further cause the first device to determine whether the condition for switching to the target BWP is fulfilled by:
determining whether an active BWP is configured with a RACH resource for the reduced capability; and
in accordance with a determination that the active BWP is not configured the RACH resource for reduced capability, switching from the active BWP to the target BWP which is configured with the RACH resource for reduced capability.

7. The first device of claim 1, wherein the at least one memory and the computer program codes are configured to, with the at least one processor, further cause the first device to determine whether the condition for switching to the target BWP is fulfilled by:
determining whether an active BWP is configured with a RACH resource for a slice; and
in accordance with a determination that the active BWP is not configured the RACH resource for the slice, switching from the active BWP to the target BWP which is configured with the RACH resource for the slice.

8. The first device of claim 1, wherein the at least one memory and the computer program codes are configured to, with the at least one processor, further cause the first device to:
determine whether an active BWP of the first device is configured with a RACH configuration based on the set of RACH configurations;
in accordance with a determination that the active BWP is not configured with the RACH configuration, switch to an initial BWP; and
wherein the at least one memory and the computer program codes are configured to, with the at least one processor, further cause the first device to determine whether the condition for switching to the target BWP is fulfilled by:
in accordance with a determination that the initial BWP does not support the at least one feature, determining whether the condition for switching to the target BWP is fulfilled.

9. The first device of claim 1, wherein the at least one memory and the computer program codes are configured to, with the at least one processor, further cause the first device to determine whether the condition for switching to the target BWP is fulfilled by:
performing a random access on an active BWP which is configured with a common RACH resource; and
in accordance with a determination that the number of random access failures on the active BWP exceeds a number threshold, determining that the condition for switching to the target BWP is fulfilled.

10. The first device of claim 1, wherein the at least one memory and the computer program codes are configured to, with the at least one processor, further cause the first device to receive the configuration information by:
receiving the configuration information via one of:
a radio resource control (RRC) signaling,
a medium access control (MAC) signaling, or
a physical (PHY) signaling.

11. The first device of claim 1, wherein the first device is a terminal device and the second device is a network device.

12. A second device, comprising:
at least one processor; and
at least one memory including computer program code;
wherein the at least one memory and the computer program code are configured to, with the at least one processor, cause the second device to:
transmit, to a first device, configuration information indicating: a set of bandwidth parts (BWPs) and a set of random access channel (RACH) configurations of the set of BWPs; and
perform a random access with the first device on a target BWP, wherein a random access procedure is triggered based on at least one feature and the target BWP is configured with a RACH resource for the at least one feature.

13. The second device of claim 12, wherein the set of RACH configurations further comprises the condition for switching to the target BWP.

14. The second device of claim 12, wherein the at least one feature comprises one of:
a reduced capability,
a small data transmission,
a coverage enhancement, or
a slice.

15. The second device of claim 12, wherein the condition indicates a first reference signal received power (RSRP) threshold for coverage enhancement.

16. The second device of claim 12, wherein the condition indicates a second RSRP threshold associated with reduced capability.

17. The second device of claim 12, wherein the at least one memory and the computer program codes are configured to, with the at least one processor, further cause the first device to transmit the configuration information by:
transmitting the configuration information via one of:
a radio resource control (RRC) signaling,
a medium access control (MAC) signaling, or
a physical (PHY) signaling.

18. The second device of claim 12, wherein the first device is a terminal device and the second device is a network device.

19. A method, comprising:
receiving, at a first device and from a second device, configuration information indicating: a set of bandwidth parts (BWPs) and a set of random access channel (RACH) configurations of the set of BWPs;
determining, at the first device, that a random access procedure is triggered based on at least one feature;
determining whether a condition for switching to a target BWP is fulfilled based on the set of RACH configurations, wherein the target BWP is configured with a RACH resource for the at least one feature; and
in accordance with a determination that the condition is fulfilled, performing the random access with the second device on the target BWP.

20. The method of claim 19, wherein the set of RACH configurations further comprises the condition for switching to the target BWP.

21. The method of claim 19, wherein the at least one feature comprises one of:
a reduced capability,
a small data transmission,
a coverage enhancement, or
a slice.

22. The method of claim 19, wherein the condition indicates a first reference signal received power (RSRP) threshold for coverage enhancement, wherein the method further comprises:
determining whether an active BWP of the first device is configured with a RACH resource for coverage enhancement based on the set of RACH configurations;
in accordance with a determination that the active BWP is not configured with the RACH resource for coverage enhancement, determining a value of a RSRP on the active BWP; and
wherein determining whether the condition for switching to the target BWP is fulfilled comprises:
comparing the value of the RSRP of the active BWP with the first RSRP threshold;
in accordance with a determination that the value of RSRP is below the first RSRP threshold, determining that the condition for switching to the target BWP is fulfilled; and
switching from the active BWP to the target BWP which is configured with the RACH resource for coverage enhancement.

23. The method of claim 19, wherein the condition indicates a second RSRP threshold associated with reduced capability, wherein the method further comprises:
determining a value of a RSRP on an active BWP; and
wherein determining whether the condition for switching to the target BWP is fulfilled comprises:
comparing the value of the RSRP of the active BWP with the second RSRP threshold;
in accordance with a determination that the value of the RSRP is below the second RSRP threshold, determining that the condition for switching to the target BWP is fulfilled; and
switching from the active BWP to the target BWP which is configured with the RACH resource for reduced capability.

24. The method of claim 19, wherein determining whether the condition for switching to the target BWP is fulfilled comprises:
determining whether an active BWP is configured with a RACH resource for the reduced capability; and
in accordance with a determination that the active BWP is not configured the RACH resource for reduced capability, switching from the active BWP to the target BWP which is configured with the RACH resource for reduced capability.

25. The method of claim 19, wherein determining whether the condition for switching to the target BWP is fulfilled comprises:
determining whether an active BWP is configured with a RACH resource for a slice; and
in accordance with a determination that the active BWP is not configured the RACH resource for the slice, switching from the active BWP to the target BWP which is configured with the RACH resource for the slice.

26. The method of claim 19, further comprising:
determining whether an active BWP of the first device is configured with a RACH configuration based on the set of RACH configurations;
in accordance with a determination that the active BWP is not configured with the RACH configuration, switching to an initial BWP; and
wherein determining whether the condition for switching to the target BWP is fulfilled comprises:
in accordance with a determination that the initial BWP does not support the at least one feature, determining whether the condition for switching to the target BWP is fulfilled.

27. The method of claim 19, wherein determining whether the condition for switching to the target BWP is fulfilled comprises:
performing a random access on an active BWP which is configured with a common RACH resource; and
in accordance with a determination that the number of random access failures on the active BWP exceeds a number threshold, determining that the condition for switching to the target BWP is fulfilled.

28. The method of claim 19, wherein receiving the configuration information comprises:
receiving the configuration information via one of:
a radio resource control (RRC) signaling,
a medium access control (MAC) signaling, or
a physical (PHY) signaling.

29. The method of claim 19, wherein the first device is a terminal device and the second device is a network device.

30. A method, comprising:
transmitting, at a second device and to a first device, configuration information indicating: a set of bandwidth parts (BWPs) and a set of random access channel (RACH) configurations of the set of BWPs; and
performing a random access with the first device on a target BWP, wherein a random access procedure is triggered based on at least one feature and the target BWP is configured with a RACH resource for the at least one feature.

31. The method of claim 30, wherein the set of RACH configurations further comprises the condition for switching to the target BWP.

32. The method of claim 30, wherein the at least one feature comprises one of:
a reduced capability,
a small data transmission,
a coverage enhancement, or
a slice.

33. The method of claim 30, wherein the condition indicates a first reference signal received power (RSRP) threshold for coverage enhancement.

34. The method of claim 30, wherein the condition indicates a second RSRP threshold associated with reduced capability.

35. The method of claim 30, wherein transmitting the configuration information comprises:
transmitting the configuration information via one of:
a radio resource control (RRC) signaling,
a medium access control (MAC) signaling, or
a physical (PHY) signaling.

36. The method of claim 30, wherein the first device is a terminal device and the second device is a network device.

37. (canceled)

38. (canceled)

39. A computer program product comprising a non-transitory computer readable medium comprising program instructions for causing an apparatus to perform the method of claim 19.

40. A computer program product comprising a non-transitory computer readable medium comprising program instructions for causing an apparatus to perform the method of claim 30.
